(19) United States
(12) Patent Application Publication
(10) Pub. No.: US 2025/0272167 A1
(43) Pub. Date: Aug. 28, 2025

(54) PARTITION-AWARE BROADCAST OPERATION FILTERING IN A MULTIPROCESSOR SYSTEM

(71) Applicant: NVIDIA CORPORATION, Santa Clara, CA (US)

(72) Inventors: Lennard STREAT, South San Francisco, CA (US); Yudong ZHAO, Sunnyvale, CA (US); Vaishali KULKARNI, Sunnyvale, CA (US); Timothy Ian MILNE, New Hill, NC (US); Ashish Kumar MAURYA, Santa Clara, CA (US); Debajit BHATTACHARYA, San Jose, CA (US); Wishwesh Anil GANDHI, Sunnyvale, CA (US)

(21) Appl. No.: 18/584,772

(22) Filed: Feb. 22, 2024

(51) Int. Cl. G06F 9/54

(52) U.S. Cl. CPC G06F 9/542

(57) ABSTRACT

Various embodiments include techniques for processing broadcast operations in a computing system. Typically, broadcast operations are transmitted to all portions of a particular subsystem, such as all cache slices in a cache memory. As a result, a process that issues a broadcast operation can interfere with one or more other processes that access portions of the subsystem not assigned to the process. To prevent such interference, logic in the computing system filters broadcast operations so as to transmit the broadcast operation to only the relevant portions assigned to the process that issued the broadcast operation. The logic tracks acknowledgments from the relevant portions and, when all pending acknowledgments have been received, the logic transmits a single acknowledgement to the process that issued the broadcast operation. The logic is dynamically configurable such that the logic can change the portions of the subsystem assigned to each process as needed.

### BACKGROUND

### Field of the Various Embodiments

Various embodiments relate generally to computer system architectures and, more specifically, to partition-aware broadcast operation filtering in a multiprocessor system.

### Description of the Related Art

A computing system generally includes, among other things, one or more processing units, such as central processing units (CPUs) and/or graphics processing units (GPUs), one or more memory systems, and one or more networks. Processing units execute user mode software applications, which submit and launch compute tasks, executing on one or more compute engines included in the processing units. In operation, processing units load data from the one or more memory systems, perform various arithmetic and logical operations on the data, and store data back to the one or more memory systems. One of the ways the processing units can communicate with the memory systems is via a network interface card (NIC). The NIC provides an interface between the processing units and the memory systems over various network interface protocols, including Ethernet, Peripheral Component Interconnect Express (PCIe), and/or the like.

A given processing unit can be configured to implement multiple processing contexts simultaneously by dividing the resources of the processing unit among multiple engines. These multiple engines are referred to herein as simultaneous multiple context (SMC) engines or multi-instance GPUs (MIGs). Each of the engines is allocated a portion of the processing unit, including a portion of the compute resources, graphics resources, memory resources, and/or the like. The portion of the compute resources, graphics resources, memory resources allocated to an engine is referred to as an SMC partition, a MIG partition, or, more simply, a partition. Modern CPUs, GPUs, and other processing units are becoming increasingly virtualized, leading to an increased need for isolation between different partitions. This isolation helps to ensure that partitions executing on a single processing unit do not interfere with one another. In general, partitions should be independent and free from interference from one another. Certain operations performed by a processing unit are typically broadcast to the entirety of the memory subsystem. These broadcast operations include cache state management operations (referred to herein as cacheops), memory synchronization operations, such as memory barrier operations (referred to herein as membars), and/or the like. Because different portions of the memory system are accessed by different partitions, broadcast operations performed by one partition can affect portions of memory accessed by one or more other partitions. However, when a broadcast operation affects portions of the memory system accessed by multiple partitions, the partitions are no longer isolated from one another. Interference between partitions can have a negative impact on performance and can cause processes executing on one partition to affect processes executing on one or more other partitions, either intentionally or unintentionally. In some examples, a virtualized environment can include two user processes that have been mapped to separate virtualized partitions of the same processing unit. The first process can be a legitimate process, while the second process can include a malicious software application attempting a denial-of-service attack on the first process. In such examples, the second process can attempt to harm the first process by issuing cache state management operations that corrupt the cache state in the first process. An example symptom of this scenario is that the first legitimate process can cause excessive cache memory accesses due to the corrupted cache state. Such a condition of excessive cache memory accesses is referred to herein as thrashing the cache memory.

In some examples, one process executing on one partition can continuously issue memory synchronization operations in an attempt to synchronize across portions of memory that are mapped to the other processes executing on one or more other partitions, referred to herein as priming the pump. These memory synchronization operations enforce ordering requirements of memory operations by pushing prior memory operations to a point of coherence before executing instructions after the memory synchronization operation. A malicious process can use this behavior of memory synchronization operations to clog up the downstream path to memory by issuing a large number of memory operations and then issuing a memory synchronization operation. This malicious use of memory synchronization operations can cause increased latency to memory synchronization operations issued by legitimate processes. In the extreme, a malicious process continuously issuing memory synchronization operations can cause significant performance degradation for legitimate processes.

Further, as data sets become significantly larger, processes can benefit from utilizing multiple processing units in a parallel processor to execute concurrent processes on different portions of the same data set in memory, referred to herein as a divide and conquer method. As the number of concurrently executing processes increases, the compute resources, graphics resources, and memory resources are divided and shared in smaller granularities among those processes. As a result, memory synchronization operations may be utilized more frequently in order to synchronize data among a large number of processes.

As the foregoing illustrates, what is needed in the art are more effective techniques for processing broadcast operations in a computing system.

### SUMMARY

Various embodiments of the present disclosure set forth a computer-implemented method for processing broadcast operations in a computing system. The method includes determining a partition identifier associated with a broadcast operation based on an identifier of a first user process that issued the broadcast operation. The method further includes generating a sub-partition mask based on the partition identifier, wherein the sub-partition mask identifies a subset of system components included in a plurality of system components assigned to the first user process. The method further includes transmitting the broadcast operation to the subset of system components based on the sub-partition mask.

Other embodiments include, without limitation, a system that implements one or more aspects of the disclosed techniques, and one or more computer readable media including instructions for performing one or more aspects of the disclosed techniques, as well as a method for performing one or more aspects of the disclosed techniques.

At least one technical advantage of the disclosed techniques relative to the prior art is that the disclosed techniques enable filtering of broadcast memory operations, such as cache state management operations, memory synchronization operations, and/or the like, on a per operation basis in a scalable, programmable way. Further, partition mapping can be dynamically reconfigured to adapt to changing of memory partition layout. The dynamic configuration can be updated for a subset of the active user processes or for all active user processes without impacting other active processes. As a result, only the user processes impacted by the reconfiguration are stalled, while other user processes not impacted by the reconfiguration continue to execute. Another advantage of the disclosed techniques is that isolation of operations among virtual processes is improved relative to conventional techniques. This improved isolation can lead to better security, reduced interference, and increased performance for the processes that are concurrently executing on a parallel processor. These advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computing system configured to implement one or more aspects of the various embodiments;

FIG. 2 is a block diagram of a parallel processing unit (PPU) included in the accelerator processing subsystem of FIG. 1, according to various embodiments;

FIG. 3 is a block diagram of a general processing cluster (GPC) included in the parallel processing unit (PPU) of FIG. 2, according to various embodiments;

FIG. 4 is a block diagram of a broadcast operation subsystem for the SM of FIG. 3, according to various embodiments;

FIG. 5 is a block diagram of the partition lookup table and the mask generator of the broadcast operation subsystem of FIG. 4, according to various embodiments; and

FIGS. 6A-6B set forth a flow diagram of method steps for processing broadcast operations executed by an SM of FIG. 3, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

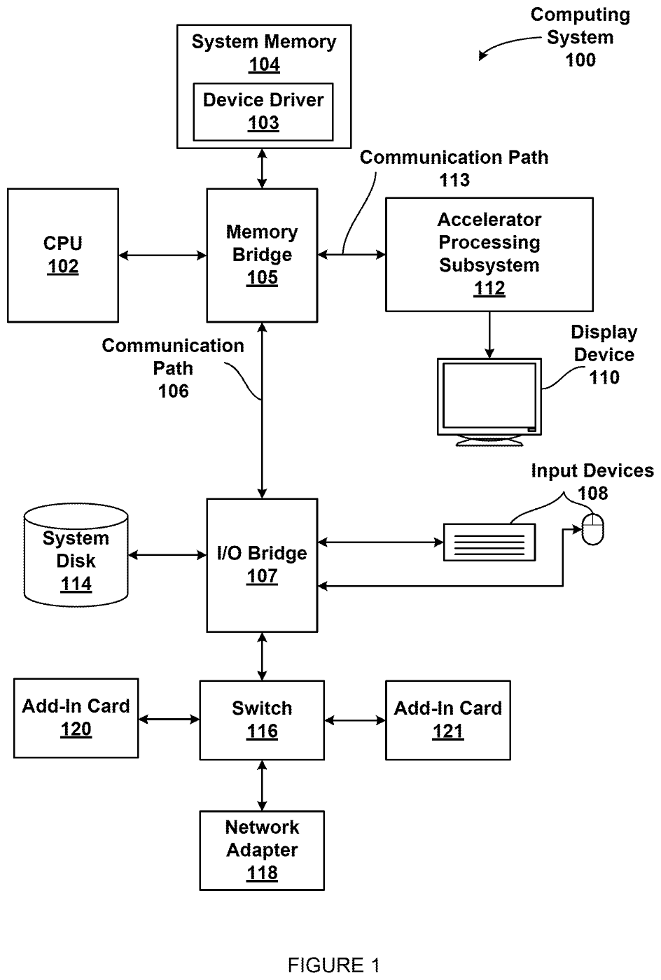

FIG. 1 is a block diagram of a computing system 100 configured to implement one or more aspects of the various embodiments. As shown, computing system 100 includes, without limitation, a central processing unit (CPU) 102 and a system memory 104 coupled to an accelerator processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. In some examples, input devices 108 are employed to verify the identities of one or more users in order to permit access of computing system 100 to authorized users and deny access of computing system 100 to unauthorized users. Switch 116 is configured to provide connections between I/O bridge 107 and other components of the computing system 100, such as a network adapter 118 and various add-in cards 120 and 121. In some examples, network adapter 118 serves as the primary or exclusive input device to receive input data for processing via the disclosed techniques.

As also shown, I/O bridge 107 is coupled to a system disk 114 that may be configured to store content and applications and data for use by CPU 102 and accelerator processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, Peripheral Component Interconnect Express (PCIe), HyperTransport, or any other bus or point-to-point communication protocol known in the art.

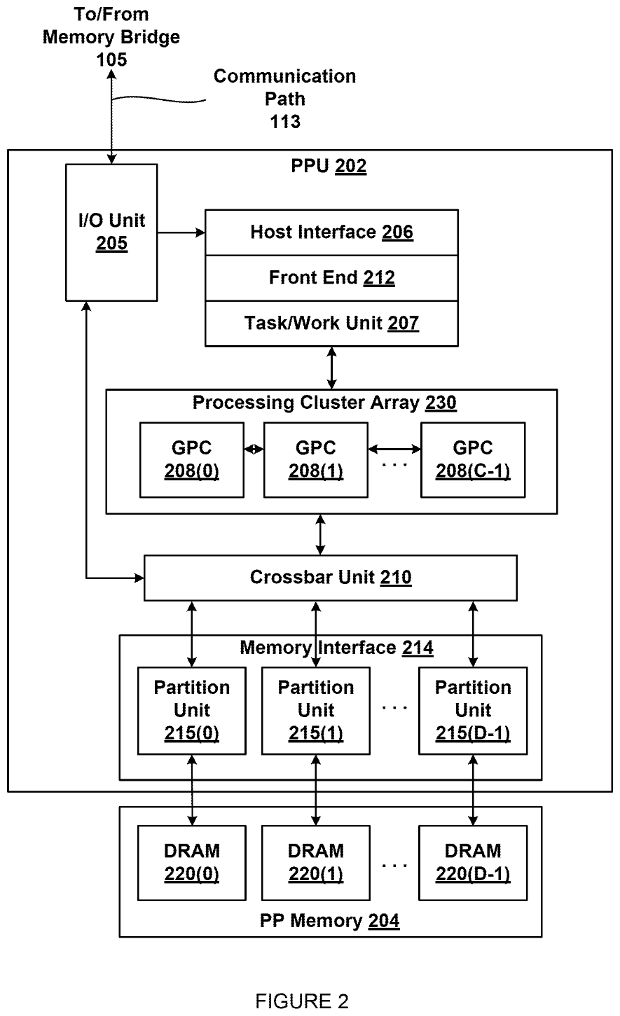

In some embodiments, accelerator processing subsystem 112 comprises a graphics subsystem that delivers pixels to a display device 110 that may be any conventional cathode ray tube, liquid crystal display, light-emitting diode display, or the like. In such embodiments, the accelerator processing subsystem 112 incorporates circuitry optimized for graphics and video processing, including, for example, video output circuitry. As described in greater detail below in FIG. 2, such circuitry may be incorporated across one or more accelerators included within accelerator processing subsystem 112. An accelerator includes any one or more processing units that can execute instructions such as a central processing unit (CPU), a parallel processing unit (PPU) of FIGS. 2-4, a graphics processing unit (GPU), a direct memory access (DMA) unit, an intelligence processing unit (IPU), neural accelerator unit (NAU), tensor processing unit (TPU), neural network processor (NNP), a data processing unit (DPU), a vision processing unit (VPU), an application specific integrated circuit (ASIC), a field-programmable gate array (FPGA), and/or the like.

In some embodiments, accelerator processing subsystem 112 includes two processors, referred to herein as a primary processor (normally a CPU) and a secondary processor. Typically, the primary processor is a CPU and the secondary processor is a GPU. Additionally or alternatively, each of the primary processor and the secondary processor may be any one or more of the types of accelerators disclosed herein, in any technically feasible combination. The secondary processor receives secure commands from the primary processor via a communication path that is not secured. The secondary processor accesses a memory and/or other storage system, such as system memory 104, Compute eXpress Link (CXL) memory expanders, memory managed disk storage, on-chip memory, and/or the like. The secondary processor accesses this memory and/or other storage system across an insecure connection. The primary processor and the secondary processor may communicate with one another via a GPU-to-GPU communications channel, such as Nvidia Link (NVLink). Further, the primary processor and the secondary processor may communicate with one another via network adapter 118. In general, the distinction between an insecure communication path and a secure communication path is application dependent. A particular application program generally considers communications within a die or package to be secure. Communications of unencrypted data over a standard communications channel, such as PCIe, are considered to be unsecure.

In some embodiments, the accelerator processing subsystem 112 incorporates circuitry optimized for general purpose and/or compute processing. Again, such circuitry may be incorporated across one or more accelerators included within accelerator processing subsystem 112 that are configured to perform such general purpose and/or compute operations. In yet other embodiments, the one or more accelerators included within accelerator processing subsystem 112 may be configured to perform graphics processing, general purpose processing, and compute processing operations. System memory 104 includes at least one device driver 103 configured to manage the processing operations of the one or more accelerators within accelerator processing subsystem 112.

In various embodiments, accelerator processing subsystem 112 may be integrated with one or more of the other elements of FIG. 1 to form a single system. For example, accelerator processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of accelerator processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, accelerator processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the accelerator processing subsystem 112 of FIG. 1, according to various embodiments. Although FIG. 2 depicts one PPU 202, as indicated above, accelerator processing subsystem 112 may include any number of PPUs 202. Further, the PPU 202 of FIG. 2 is one example of an accelerator included in accelerator processing subsystem 112 of FIG. 1. Alternative accelerators include, without limitation, CPUs, GPUs, DMA units, IPUs, NPUs, TPUs, NNPs, DPUs, VPUs, ASICs, FPGAs, and/or the like. The techniques disclosed in FIGS. 2-4 with respect to PPU 202 apply equally to any type of accelerator(s) included within accelerator processing subsystem 112, in any combination. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computing system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. Additionally or alternatively, processors and/or accelerators other than CPU 102 may write one or more streams of commands for PPU 202 to a data structure. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computing system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computing system 100 may be varied. In some embodiments, accelerator processing subsystem 112, which includes at least one PPU 202, is implemented as an add-in card that can be inserted into an expansion slot of computing system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≥1. Each partition unit 215 is coupled to one or more dynamic random access memories (DRAMs) 220 residing within PP memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPC 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity, and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within accelerator processing subsystem 112, or another accelerator processing subsystem 112 within computing system 100.

As noted above, any number of PPUs 202 may be included in an accelerator processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

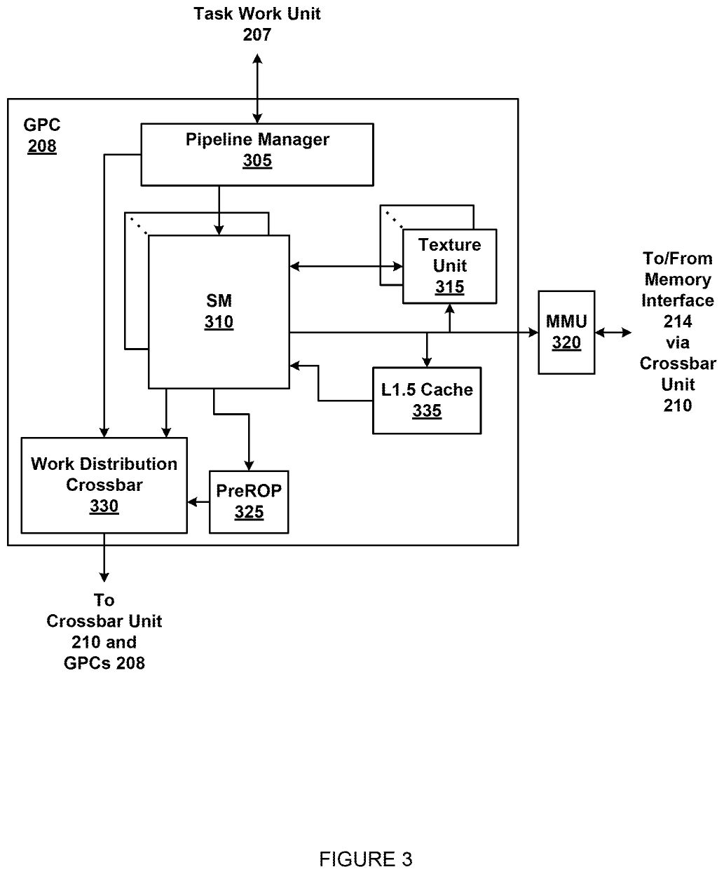

FIG. 3 is a block diagram of a general processing cluster (GPC) 208 included in the parallel processing unit (PPU) 202 of FIG. 2, according to various embodiments. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (e.g., AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310. In various embodiments, a software application written in the compute unified device architecture (CUDA) programming language describes the behavior and operation of threads executing on GPC 208, including any of the above-described behaviors and operations. A given processing task may be specified in a CUDA program such that the SM 310 may be configured to perform and/or manage general-purpose compute operations.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the various embodiments of the present disclosure.

Please note, as used herein, references to shared memory may include any one or more technically feasible memories, including, without limitation, a local memory shared by one or more SMs 310, or a memory accessible via the memory interface 214, such as a cache memory, parallel processing memory 204, or system memory 104. Please also note, as used herein, references to cache memory may include any one or more technically feasible memories, including, without limitation, an L1 cache, an L1.5 cache, and the L2 caches.

### Processing Broadcast Operations

Various embodiments include techniques for processing broadcast operations, also referred to herein as broadcast requests, in a multiprocessor system.

A broadcast operation includes one or more executable instructions to perform a certain operation, such as storing data in memory, loading data from memory, and/or the like. The techniques reduce or eliminate interference between hardware units being virtualized among multiple partitions that are executing separate processes. The techniques detect the portion of memory allocated to each user process and reduce the scope of a broadcast operation to the portions allocated to the user process that executed the broadcast operation.

Broadcast logic included in a broadcast operations subsystem filters each broadcast operation so that the broadcast operation is not transmitted to the entirety of the physical memory subsystem. Instead, the broadcast logic performs a software-programmable filtering operation to transmit the broadcast operation to a subset of the memory subsystem associated with the processing unit that issued the broadcast operation. In this manner, the broadcast logic functionally isolates user processes from one another by targeting broadcast operations to a relevant subset of the memory subsystem rather than to the entirety of the memory subsystem.

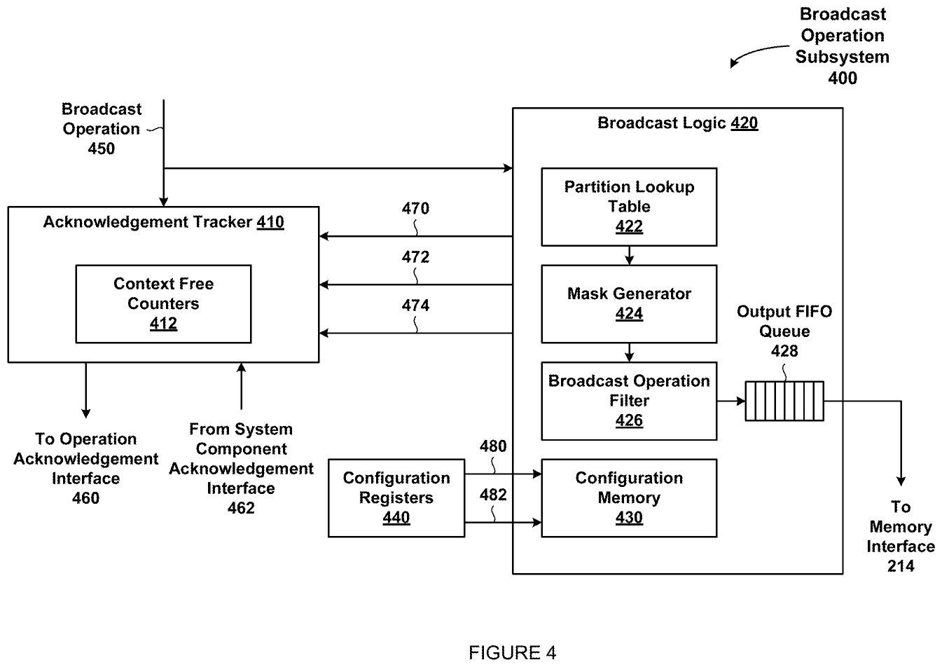

FIG. 4 is a block diagram of a broadcast operation subsystem 400 for the SM 310 of FIG. 3, according to various embodiments. As shown, broadcast operation subsystem 400 includes, without limitation, an acknowledgment tracker 410, broadcast logic 420, and configuration registers 440. Acknowledgment tracker 410 includes, without limitation, context free counters 412. Broadcast logic 420 includes, without limitation, a partition lookup table 422, a mask generator 424, a broadcast operation filter 426, an output FIFO queue 428, and configuration memory 430.

Prior to executing user processes, SM 310 completes a boot sequence. In various embodiments, SM 310 performs a boot sequence after a power on event, a reset event, and/or the like. During the boot sequence, SM 310 performs various housekeeping functions, such as initiating various system components, executing an operating system, and launching one or more user processes. Such user processes can execute one or more processes to perform work for a software application executing on SM 310. When executing on SM 310, the user processes can generate and transmit memory operations. The memory operations can include load operations to read data from memory, store operations to store data in memory, and/or the like. Memory operations are also referred to herein as memory requests or, more simply, as operations or requests. Certain memory operations generated by a user process are directed to a specific memory location or a specific component that is allocated to the particular SM 310 that is executing the user process. Certain other memory operations generated by a user process are directed to multiple memory locations and/or multiple components that are allocated to various SMs 310, including one or more SMs 310 that are not executing the user process. This latter class of memory operations are referred to herein as broadcast operations. As a result, one SM 310 that generates and transmits a broadcast operation can interfere with, and can negatively impact, other user processes, including user processes executing on other SMs 310.

To mitigate the negative impact of broadcast operations on user processes executing on other SMs 310, broadcast operations are intercepted and processed by broadcast operations subsystem 400. When broadcast operations subsystem 400 receives a broadcast operation 450, broadcast operations subsystem 400 forwards the broadcast operation 450 to acknowledgement tracker 410 and broadcast logic 420. The broadcast operation 450 includes, or is otherwise associated with, a process identifier (ID) that identifies the user process that generated the broadcast operation 450. Upon receiving a broadcast operation 450, acknowledgement tracker 410 assigns one of the context free counters 412 to the broadcast operation 450 and associates the assigned context free counter 412 to the process ID included with the broadcast operation 450.

In some examples, a conventional acknowledgement tracker 410 can include standard counters. In such examples, acknowledgement tracker 410 and broadcast logic 420 can receive a broadcast operation 450 from a user process. Broadcast logic 420 can process this broadcast operation 450 to format and generate one or more operations to satisfy the broadcast operation 450, where each operation is generated using a counter instead of the sub-partition mask described herein. Acknowledgement tracker 410 can also process the broadcast operation 450 to initialize a counter to a starting value. Acknowledgement tracker 410 determines the starting value based on certain context, such as the floorsweeping configuration that removes non-functional components that are fused off and not used. As a result, such a conventional acknowledgement tracker 410 and standard counters need to be aware of the system context including the floorsweeping configuration. As acknowledgement tracker 410 receives acknowledgments resulting from operations generated by broadcast logic 420, each acknowledgment can decrement the corresponding standard counter in acknowledgement tracker 410. As a result, these standard counters are essentially monotonic.

By contrast, acknowledgement tracker 410 employs context free counters 412 such that acknowledgement tracker 410 does not need to track the floorsweeping configuration. Further, with context free counters 412 such that acknowledgement tracker 410 does not need to track the number of components involved in a broadcast operation as determined by mask generator 424 and broadcast operation filter 426. Instead, acknowledgement tracker 410 can rely solely on the operation pushed signal 470, the all operations pushed signal 472, and the returned acknowledgements described herein to update context free counters 412.

Upon receiving the broadcast operation 450, broadcast logic 420 forwards the broadcast operation 450 to partition lookup table 422. Broadcast logic 420 extracts a process ID from metadata included in, or otherwise associated with, the broadcast operation. Broadcast logic 420 uses the process ID as a key that identifies a corresponding lookup table entry included in partition lookup table 422. The lookup table entry includes a configuration associated with the user process that generated the broadcast operation 450, where the configuration includes a partition ID of the partition assigned to the user process. Broadcast logic 420 accesses the lookup table entry and extracts the partition ID from the lookup table entry. The partition ID corresponds to a partition that is assigned to the user process that generated the broadcast operation 450. In some examples, more than one partition can be assigned to the user process that generated the broadcast operation 450. In such examples, the lookup table entry can include multiple partition IDs, and the techniques disclosed herein can be repeated for each partition ID included in the lookup table entry. Broadcast operation 450 transmits the partition ID from partition lookup table 422 to mask generator 424.

Mask generator 424 applies a function to the partition ID to generate a sub-partition mask. In some examples, the sub-partition mask includes a bit mask, where each bit included in the bit mask corresponds to a different system component included in the set of system components within computing system 100. For each bit included in the bit mask, if the bit is in a first logic state, such as a logic ‘1’ state, then a system component corresponding to the bit is included in the subset of system components assigned to the user process that generated the broadcast operation 450. For each bit included in the bit mask, if the bit is in a second logic state, such as a logic ‘0’ state, then a system component corresponding to the bit is excluded from the subset of system components assigned to the user process that generated the broadcast operation 450. Mask generator 424 transmits the sub-partition mask to broadcast operation filter 426.

Broadcast operation filter 426 converts the sub-partition mask into a set of system components identified by the sub-partition mask. In some examples, when the sub-partition mask includes a bit mask, broadcast operation filter 426 converts each bit included in the sub-partition mask that is in the first logic state into a system component identifier that identifies the system component corresponding to the bit. For each system component identifier, broadcast operation filter 426 generates an operation directed to the system component identified by the system component identifier. Broadcast operation filter 426 transmits the set of operations to output FIFO queue 428. Broadcast operation filter 426 refrains from generating operations for system components that are not assigned to the user process that generated the broadcast operation 450.

Output FIFO queue 428 temporarily stores the operations generated by broadcast operation filter 426. Broadcast logic 420 drains, e.g., periodically, output FIFO queue 428 by transmitting each operation stored in output FIFO queue 428 to the system component identified by the system component identifier included in the stored operation. Broadcast logic 420 transmits the stored operation to the system component via memory interface 214.

Configuration memory 430 includes parameters that specify how broadcast logic 420 operates. The parameters include, without limitation, software configuration parameters 480 and a partition enable parameter 482. Software configuration parameters 480 can include configuration data for each user process executed by one or more SMs 310. The configuration data for each user process can be stored in partition lookup table 422. The configuration data for each user process can be indexed and accessed by the process ID extracted by broadcast logic 420 from metadata included in, or otherwise associated with, the broadcast operation 450. The configuration data for each user process can include a partition ID associated with the user process identified by the process ID.

Software configuration parameters 480 can further include mappings between partition IDs generated by partition lookup table 422 and sub-partition masks generated by mask generator. The mappings between partition IDs and sub-partition masks can be stored in mask generator 424. Software configuration parameters 480 can further include mappings between each bit included in the sub-partition mask and the system component corresponding to the bit. The mappings between the bits of the sub-partition mask and the system components can be stored in broadcast operation filter 426.

When partition enable parameter 482 is in a first logic state, such as a logic ‘1’ state, partitioning is enabled, and broadcast operation subsystem 400 is enabled to perform broadcast operation filtering by user process as described herein. When partition enable parameter 482 is in a second logic state, such as a logic ‘0’ state, partitioning is disabled, and broadcast operation subsystem 400 is disabled from performing broadcast operation filtering.

Configuration memory 430 receives software configuration parameters 480 and partition enable parameter 482 from configuration registers 440. More specifically, configuration memory 430 stores a copy of software configuration parameters 480 and partition enable parameter 482 stored in configuration registers 440. Software configuration parameters 480 and partition enable parameter 482 can be stored in configuration registers 440 by any one or more of CPU 102 and SMs 310. The instructions to store software configuration parameters 480 and partition enable parameter 482 in configuration registers 440 can be included in an operating system, a hypervisor, a device driver 103, a user process, and/or the like.

Acknowledgement tracker 410 maintains status of outstanding acknowledgements associated with operations generated by broadcast operation filter 426 and transmitted by output FIFO queue 428 to system components via memory interface 214. Acknowledgement tracker 410 receives signals and/or data from broadcast logic 420 including, without limitation, an operation pushed signal 470, an all operations pushed signal 472, and process ID 474. When broadcast logic 420 processes a broadcast operation 450, broadcast operation filter 426 can generate multiple operations, where each operation corresponds to a different system component identified by the sub-partition mask generated by mask generator 424. When output FIFO queue 428 pushes one of these operations generated from the broadcast operation 450 to the system component via memory interface 214, broadcast logic 420 generates an operation pushed signal 470 along with the process ID 474 of the user process that generated the broadcast operation 450. In response, acknowledgement tracker 410 increments a context free counter 412 assigned to the user process identified by the process ID 474. Subsequently, the system component processes the operation and transmits an acknowledgement, along with the process ID 474, to acknowledgement tracker 410 via system component acknowledgement interface 462. In response, acknowledgement tracker 410 decrements the context free counter 412 assigned to the user process identified by the process ID 474.

As a result, if the context free counter 412 for a user process is non-zero, then one or more acknowledgements from system components are pending. If the context free counter 412 for a user process is zero, then all operations generated by broadcast operation filter 426 and pushed by output FIFO queue 428 have been processed. However, broadcast operation filter 426 may still be in the process of generating further operations for the various system components and/or output FIFO queue 428 may still be in the process of pushing the operations to the system components. Therefore, when broadcast operation filter 426 generates the final operation for a broadcast operation 450, and when output FIFO queue 428 pushes the final operation to the system component, broadcast logic 420 further generates an all operations pushed signal 472 along with the operation pushed signal 470 and the process ID 474 of the user process that generated the broadcast operation 450. In response, acknowledgement tracker 410 increments a context free counter 412 assigned to the user process identified by the process ID 474. Further, acknowledgement tracker 410 sets a tag for the context free counter 412 indicating that all operations generated from the current broadcast operation 450 have been pushed.

Consequently, acknowledgement tracker 410 tracks two conditions. The first condition is that the context free counter 412 has a value of zero, indicating that the number of pending acknowledgements from operations being processed by system components is zero. The second condition is that acknowledgement tracker 410 has received an all operations pushed signal 472 and has set a tag for the context free counter 412 indicating that all operations generated from the current broadcast operation 450 have been pushed. When both conditions are met, then the broadcast operation 450 has been processed by all system components assigned to the user process that generated the broadcast operation 450. In response, acknowledgement tracker 410 generates an acknowledgement and transmits the acknowledgement to the user process that generated the broadcast operation 450.

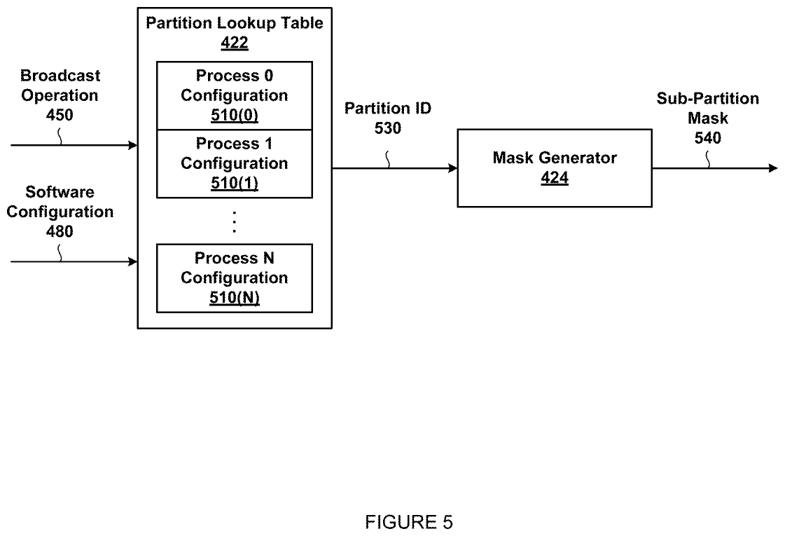

FIG. 5 is a block diagram of the partition lookup table 422 and the mask generator 524 of the broadcast operation subsystem 400 of FIG. 4, according to various embodiments. As shown, partition lookup table 422 includes, without limitation, process configurations 512 for each executing user process. In some examples, N user processes are executing, where each of the N user processes corresponds to a different process configuration 512. As shown, partition lookup table 422 includes a process 0 configuration 512(0) corresponding to a user process 0, a process 1 configuration 512(1) corresponding to a user process 1, and so on, up to a process N configuration 512(N) corresponding to a user process N.

As described herein, upon receiving the broadcast operation 450, broadcast logic 420 forwards the broadcast operation 450 to partition lookup table 422. Broadcast logic 420 extracts a process ID from metadata included in, or otherwise associated with, the broadcast operation. Broadcast logic 420 uses the process ID as a key that identifies a corresponding lookup table entry included in partition lookup table 422. The lookup table entry includes a configuration associated with the user process that generated the broadcast operation 450. Broadcast logic 420 accesses the lookup table entry and extracts a partition ID 530 from the lookup table entry. Broadcast operation 450 transmits the partition ID 530 from partition lookup table 422 to mask generator 424.

Mask generator 424 applies a function to the partition ID 530 to generate a sub-partition mask 540. In some examples, the sub-partition mask 540 includes a bit mask, where each bit included in the bit mask corresponds to a different system component included in the set of system components within computing system 100. For each bit included in the bit mask, if the bit is in a first logic state, such as a logic ‘1’ state, then a system component corresponding to the bit is included in the subset of system components assigned to the user process that generated the broadcast operation 450. For each bit included in the bit mask, if the bit is in a second logic state, such as a logic ‘0’ state, then a system component corresponding to the bit is excluded from the subset of system components assigned to the user process that generated the broadcast operation 450. Mask generator 424 transmits the sub-partition mask 540 to broadcast operation filter 426.

Broadcast logic 420 can dynamically configure partition lookup table 422 and/or the mappings of the partition ID 530 to sub-partition mask 540 stored in mask generator 424 while user processes are executing. More generally, a configuration update process can be implemented by hardware (such as broadcast logic 420), by software, or by a combination of hardware and software. In some examples, broadcast logic 420 waits until user processes impacted by the configuration in an idle state. In some examples, the idle state of the user processes can be monitored by and/or managed by software. More specifically, the idle state of the user processes can be monitored by and/or managed by an operating system, hypervisor, device driver 103, user process, and/or the like. In such examples, software can limit a configuration update to the portion of the configuration that impacts processes that are already in an idle state. In so doing, software can use any available idling mechanism, such as an idling mechanism that exists to support context switching. In this manner, this configuration update process can be part of a context switch operation. The user processes impacted by the configuration are those user processes executing on partitions that are currently being configured. User processes executing on partitions that are not currently being configured do not need to be idle and can continue to execute. This feature is useful to limit the negative performance and/or quality of service impact on user processes if an operating system or hypervisor repartitions the memory system and/or other system components while user processes are executing. Further this feature improves isolation among user processes, which can lead to better security, reduced interference, and increased performance for concurrently executing user processes.

In one example, an operating system or hypervisor can repartition the memory system and/or other system components for user process 0 and user process N while user process 1 and/or other user processes are executing. The configuration update process can wait until user process 0 and user process N are idle. User process 1 and/or other user process can continue to execute. After user process 0 and user process N are idle, user process 0 and user process N can receive software configuration parameters 480 from configuration memory 430, where the software configuration parameters 480 include data for process 0 configuration 510(0) and process N configuration 510(N). Broadcast logic 420 stores this data in process 0configuration 510(0) and process N configuration 510(N) to repartition the memory system and/or other system components for user process 0 and user process N. Because the memory system and/or other system components are not being repartitioned for process 1 and other user processes, broadcast logic 420 does not store data in process 1 configuration 510(1) or in the configurations for other user processes.

In some examples, the decision on whether to implement the configuration update process in hardware, software, or a combination of hardware and software, depends on certain system requirements. For example, a configuration update process can stall if the system detects that a broadcast operation is in process, where the broadcast operation impacts a partition being configured by the configuration update process. However, a broadcast operation can be pending, or in flight, that relies on the pre-updated configuration. Consequently, the configuration update process employs an interlock technique that drains and begins processing of pending broadcasts that rely on the pre-updated configuration before updating the configuration. The configuration update process then performs the partition configuration update and begins processing new broadcast operations that rely on the newly updated configuration. This technique is similar to a context switch operation in terms of identifying when an update window when a configuration update or a context switch can occur.

It will be appreciated that the techniques disclosed herein are illustrative and that variations and modifications are possible. The disclosed techniques are adaptive to accommodate to both balanced partitioning schemes and unbalanced partitioning schemes. With a balanced partitioning scheme, each partition is allocated the same, or substantially the same, amount of resources, where the resources include portions of system memory and/or other system components. With an unbalanced partitioning scheme, each partition can be allocated a different amount of resources. The amount of resources allocated to various partitions in an unbalanced configuration can be a function of various configurations in computing system 100, such as the state of the inbound operations. In some examples, if an operation is received from one particular engine, the operation can bypass broadcast operation filtering. In some examples, the distribution of resources among the various partitions can differ based on the configuration of each of the partitions and the associated user processes.

In some examples, multiple broadcast operations 450 can be serialized behind one another to achieve certain types of memory operation ordering. With the disclosed techniques, this constraint of serial ordering of multiple broadcast operations 450 can be relaxed. If multiple broadcast operations 450 are directed to the same partition, then the multiple broadcast operations 450 can be serialized behind one another. If, however, each broadcast operation 450 included in a set of multiple broadcast operations 450 is directed to a different partition, then the multiple broadcast operations 450 can be transmitted and/or processed in any order. Accordingly, broadcast logic 420 can include M separate sub-partition broadcast units, where M is the number of active partitions. As described herein, the number M of active partitions can be the same as, or different from, the number N of user processes.

Each inbound operation can trigger anywhere between 1 to M of the sub-partition broadcast units. An inbound operation directed to a particular partition serializes behind one or more other operations previously directed to the same partition and, therefore, transmitted to the same sub-partition broadcast unit. Therefore, an inbound operation directed to a particular partition is processed after other prior operations directed to the same partition. As a result, operation streams for different user processes executing in different physical partitions can be isolated from one another and can be processed independently from one another.

In some examples, the distribution of resources among the various partitions can differ depending on the results of floor sweeping configurations. Certain hardware resources are sometimes not fabricated correctly during fabrication of a given PPU 202, SMs 310 included in the PPU 202, and/or the like. As a result, such hardware resources can be non-functional. These non-functional hardware resources are fused off and not used. However, other hardware resources within the given PPU 202 may be functional such that that PPU 202 as a whole can still operate, albeit with lower performance. Salvaging partially functional PPUs 202 and other types of processing units and system components in this manner is referred to herein as floorsweeping.

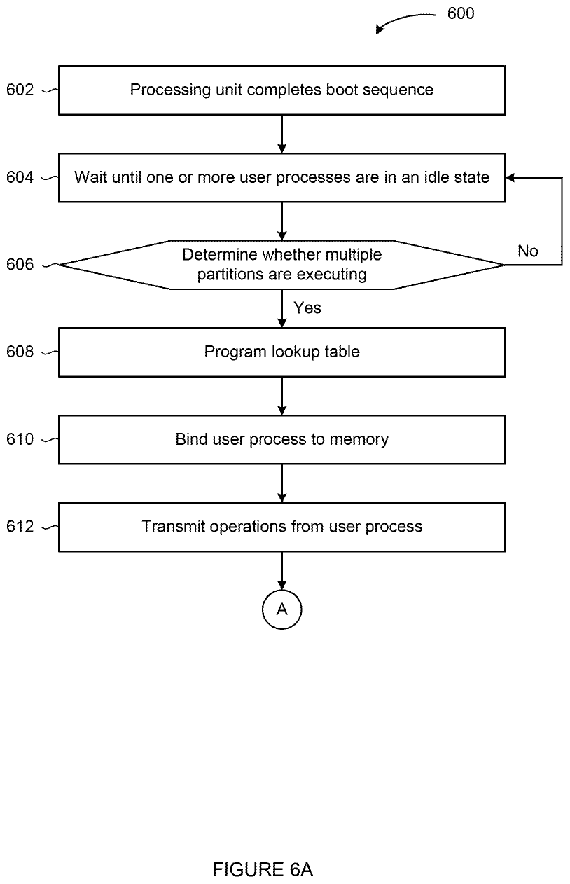

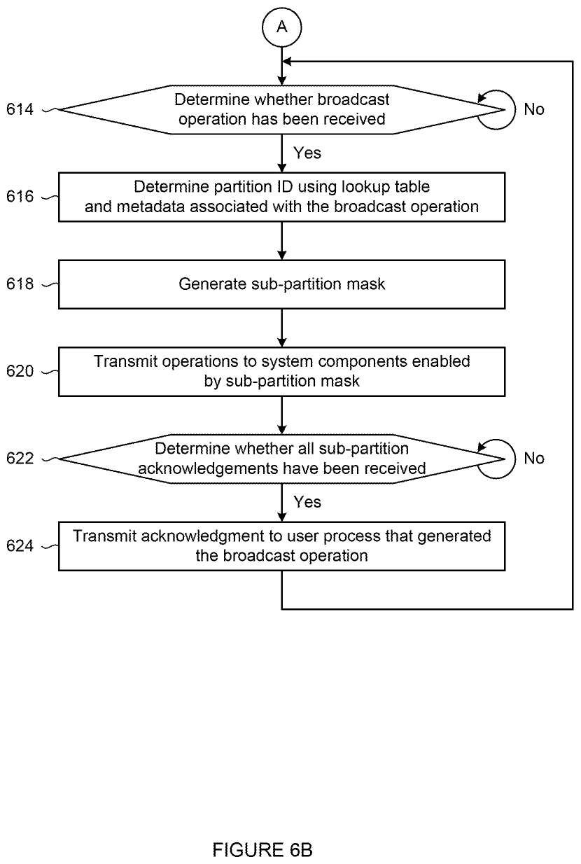

FIGS. 6A-6B set forth a flow diagram of method steps for processing broadcast operations executed by an SM 310 of FIG. 3, according to various embodiments. Additionally or alternatively, the method steps can be performed by one or more alternative processing units including, without limitation, CPUs, GPUs, DMA units, IPUs, NPUs, TPUs, NNPs, DPUs, VPUs, ASICs, FPGAs, and/or the like, in any combination. Although the method steps are described in conjunction with the systems of FIGS. 1-5, persons of ordinary skill in the art will understand that any system configured to perform the method steps, in any order, is within the scope of the present disclosure.

As shown, a method 600 begins at step 602, where a processing unit, such as an SM 310 of FIG. 3, completes a boot sequence. In various embodiments, a processing unit performs a boot sequence after a power on event, a reset event, and/or the like. During the boot sequence, the processing unit performs various housekeeping functions, such as initiating various system components, executing an operating system, and launching one or more user processes. Such user processes can execute to perform work for a software application executing on the processing unit.

At step 604, the processing unit waits until one or more user processes are in an idle state. To configure one or more partitions in order to assign system components to the various partitions, the processing unit, in conjunction with the broadcast operation subsystem, waits until user processes impacted by the configuration are idle. The user processes impacted by the configuration are those user processes executing on partitions that are currently being configured. User processes executing on partitions that are not currently being configured do not need to be idle and can continue to execute. This feature is useful to limit the performance impact on user processes if an operating system or hypervisor repartitions the memory system and/or other system components while user processes are executing.

At step 606, the processing unit determines whether multiple partitions are executing. In some examples, the processing unit sets a partition enable parameter based on whether multiple partitions are executing. If multiple partitions are executing, then the processing unit sets the partition enable parameter to a first logic state, such as a logic ‘1’ state, to enable partitioning and to enable the broadcast operation subsystem to perform broadcast operation filtering by user process as described herein. If multiple partitions are not executing, then the processing unit sets the partition enable parameter partition enable parameter to a second logic state, such as a logic ‘0’ state, to disable partitioning and to disable the broadcast operation subsystem from performing broadcast operation filtering. If multiple instances are not executing, such as when a single partition is executing, then the method proceeds to step 604, described above. If, however, multiple partitions are executing, then the method proceeds to step 608, where the processing unit programs a lookup table, such as a partition lookup table. The configuration data for each user process can be stored in this partition lookup table. The processing unit can program the data in the partition lookup table for the partitions that are being reconfigured and maintain the existing data in the partition lookup table for the partitions that are not being reconfigured.

At step 610, the processing unit binds a user process to memory. In so doing, the processing unit assigns portions of the memory system and/or other system components to each partition associated with a corresponding user process that is being reconfigured.

At step 612, the processing unit transmits operations from the user process. The operations are received and processed by a broadcast operation subsystem, such as broadcast operation subsystem 400. The operations can include one or more executable instructions to perform a certain operation, such as storing data in memory, loading data from memory, and/or the like. Further, the operations can include one or more executable instructions directed to a particular memory address and/or to a particular system component. Further, the operations can include broadcast operations, where broadcast operations include one or more executable instructions directed to multiple memory addresses and/or to multiple system components. Broadcast operations can include cache state management operations, memory synchronization operations, and/or the like.

At step 614, the broadcast operation subsystem determines whether a broadcast operation has been received. If a broadcast operation has not been received, then the method returns to step 614 to continue to wait until a broadcast operation has been received. If a broadcast operation has been received, then the method 600 proceeds to step 616, where the broadcast operation subsystem determines a partition identifier (ID) using the lookup table and metadata associated with the broadcast operation. The broadcast operation subsystem extracts a process ID from metadata included in, or otherwise associated with, the broadcast operation. The broadcast operation subsystem uses the process ID as a key that identifies a corresponding lookup table entry included in the partition lookup table. The lookup table entry includes a configuration associated with the user process that generated the broadcast operation. The broadcast operation subsystem accesses the lookup table entry and extracts a partition ID from the lookup table entry.

At step 618, the broadcast operation subsystem generates a sub-partition mask. The broadcast operation subsystem applies a function to the partition ID to generate a sub-partition mask. In some examples, the sub-partition mask includes a bit mask, where each bit included in the bit mask corresponds to a different system component included in the set of system components within the computing system. For each bit included in the bit mask, if the bit is in a first logic state, then a system component corresponding to the bit is included in the subset of system components assigned to the user process that generated the broadcast operation. For each bit included in the bit mask, if the bit is in a second logic state, then a system component corresponding to the bit is excluded from the subset of system components assigned to the user process that generated the broadcast operation.

At step 620, the broadcast operation subsystem transmits operations to system components enabled by the sub-partition mask generated at step 618. The system components can include portions of the memory subsystem and/or other system components. The broadcast operation subsystem converts the sub-partition mask into a set of system components identified by the sub-partition mask. The broadcast operation subsystem converts each bit included in the sub-partition mask that is in the first logic state into a system component identifier that identifies the system component corresponding to the bit. For each system component identifier, the broadcast operation subsystem generates an operation directed to the system component identified by the system component identifier. The broadcast operation subsystem transmits the operations to the respective system components.

At step 622, the broadcast operation subsystem determines whether all sub-partition acknowledgements have been received. In so doing, the broadcast operation subsystem tracks two conditions. The first condition is that a context free counter associated with the user process that generated the broadcast operation has a value of zero. This first condition indicates that the number of pending acknowledgements from operations being processed by system components is zero. The second condition is that the broadcast operation subsystem has received an indication that all operations generated at step 620 for the current broadcast operation have been pushed. When both conditions are met, then the broadcast operation subsystem has been processed by all system components assigned to the user process that generated the broadcast operation.

If not all sub-partition acknowledgements have been received, that is, one or both of the two conditions has not been met, then at least one sub-partition acknowledgement is pending. In such cases, the method returns to step 622 to continue to wait until all sub-partition acknowledgements have been received. If all sub-partition acknowledgements have been received, that is, both conditions have been met, then the method 600 proceeds to step 624, where the broadcast operation subsystem transmits an acknowledgment to the user process that generated the broadcast operation. The method 600 then returns to step 614, described above, to continue to wait until another broadcast operation has been received.

In sum, various embodiments include techniques for processing broadcast operations in a multiprocessor system. A broadcast operation includes one or more executable instructions to perform a certain operation, such as storing data in memory, loading data from memory, and/or the like. The techniques reduce or eliminate interference between hardware units being virtualized among multiple partitions that are executing separate processes. The techniques detect the portion of memory allocated to each user process and reduce the scope of a broadcast operation to the portions allocated to the user process that executed the broadcast operation.

Broadcast logic included in a broadcast operations subsystem filters each broadcast operation so that the broadcast operation is not transmitted to the entirety of the physical memory subsystem. Instead, the broadcast logic performs a software-programmable, filtering operation to transmit the broadcast operation to a subset of the memory subsystem associated with the processing unit that issued the broadcast operation. In this manner, the broadcast logic functionally isolates user processes from one another by targeting broadcast operations to a relevant subset of the memory subsystem rather than to the entirety of the memory subsystem.

In that regard, a software application can configure a hardware-based partition lookup table (LUT) that is accessed when processing a broadcast operation. Each broadcast operation includes a unique process functional identifier, referred to herein as a process ID. Based on the process ID, the broadcast logic identifies the partition associated with the broadcast operation and generates a partition identifier, referred to herein as a partition ID. Based on the partition ID, the broadcast logic generates a sub-partition mask that indicates the subset of the physical memory space targeted by the broadcast operation.

From the sub-partition mask, the broadcast logic generates one or more downstream memory operations to transmit the broadcast operation to the components of the partition assigned to the process that generated the broadcast operation. The broadcast logic refrains from transmitting the broadcast operation to the components of the partition that are not assigned to the process that generated the broadcast operation.

More specifically, the broadcast logic uses the sub-partition mask to map to different cache memory slices in the system. Based on the sub-partition mask, the broadcast operation is transmitted on a per-slice basis to cache memory slices assigned to the user process that issues the broadcast operation. The broadcast operation is not transmitted to cache memory slices that are not assigned to the user process that issues the broadcast operation. Isolation logic included in the broadcast logic converts each bit in the sub-partition mask into a unique slice identifier per cache memory slice. The isolation logic transmits the broadcast operation to each of the cache memory slices identified by these slice identifiers.

The partition lookup table and/or the partition ID to sub-partition mask mapping can be dynamically configured while user processes are executing. The broadcast logic waits until user processes impacted by the configuration are idle. The user processes impacted by the configuration are those user processes executing on partitions that are currently being configured. User processes executing on partitions that are not currently being configured do not need to be idle and can continue to execute. This feature is useful to limit the performance impact on user processes if an operating system or hypervisor repartitions the memory system while user processes are executing.

Additionally, the broadcast logic that tracks the completion of the broadcast operation includes an adaptively configurable acknowledgment tracker that returns acknowledgments to only the original processing unit that is executing the user process that generated the broadcast operation. The acknowledgment tracker tracks completion of downstream memory operations transmitted to the components of the partition assigned to the process that generated the broadcast operation. The acknowledgment tracker returns an acknowledgment to the user process that generated the broadcast operation if both of the following requirements are met: (1) the number of pending acknowledgements for downstream memory operations is zero; and (2) all acknowledgments have been drained from a queue included in the broadcast logic and transmitted to the remainder of the memory subsystem. These conditions are tracked by context-free counters included in the broadcast logic.

At least one technical advantage of the disclosed techniques relative to the prior art is that the disclosed techniques enable filtering of broadcast memory operations, such as cache state management operations, memory synchronization operations, and/or the like, on a per operation basis in a scalable, programmable way. Further, partition mapping can be dynamically reconfigured to adapt to changing of memory partition layout. The dynamic configuration can be updated for a subset of the active user processes or for all active user processes without impacting other active processes. As a result, only the user processes impacted by the reconfiguration are stalled, while other user processes not impacted by the reconfiguration continue to execute. Another advantage of the disclosed techniques is that isolation of operations among virtual processes is improved relative to conventional techniques. This improved isolation can lead to better security, reduced interference, and increased performance for the processes that are concurrently executing on a parallel processor. These advantages represent one or more technological improvements over prior art approaches.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for processing broadcast operations, the method comprising:
determining a partition identifier associated with a broadcast operation based on an identifier of a first user process that issued the broadcast operation;
generating a sub-partition mask based on the partition identifier, wherein the sub-partition mask identifies a subset of system components included in a plurality of system components assigned to the first user process; and
transmitting the broadcast operation to the subset of system components based on the sub-partition mask.

2. The computer-implemented method of claim 1, wherein the subset of system components comprises a subset of a memory system.

3. The computer-implemented method of claim 1, wherein the broadcast operation comprises at least one of a cache state management operation or a memory synchronization operation.

4. The computer-implemented method of claim 1, wherein determining the partition identifier comprises:
accessing an entry in a lookup table entry comprising a configuration associated with the first user process, wherein the entry is identified by the identifier of the first user process; and
extracting the partition identifier from the entry.

5. The computer-implemented method of claim 4, further comprising:
determining that the first user process is idle; and
allowing the entry in the lookup table entry to be reconfigured while a second user process is executing.

6. The computer-implemented method of claim 1, wherein the identifier of the first user process is included in metadata associated with the broadcast operation.

7. The computer-implemented method of claim 1, further comprising:
receiving an acknowledgement from each system component the subset of system components, wherein the acknowledgement indicates that the corresponding system component has processed the broadcast operation; and
in response to receiving the acknowledgement from each system component, transmitting an acknowledgement to the first user process that the broadcast operation has been processed.

8. The computer-implemented method of claim 7, further comprising:
receiving an indication that the broadcast operation has been processed by each system component included in the subset of system components,
wherein transmitting the acknowledgement to the first user process is further in response to receiving the indication that the broadcast operation has been processed by each system component.

9. The computer-implemented method of claim 1, wherein:
the sub-partition mask comprises a bit mask, and
each bit included in the bit mask corresponds to a different system component included in the plurality of system components.

10. The computer-implemented method of claim 9, wherein:
a first bit included in the bit mask is in a first logic state when a system component corresponding to the first bit is included in the subset of system components, and
the first bit included in the bit mask is in a second logic state when the system component corresponding to the first bit is excluded from the subset of system components.

11. The computer-implemented method of claim 10, further comprising:
determining that the first bit included in the bit mask is in the first logic state; and
converting the first bit into an identifier that identifies the system component corresponding to the first bit.

12. A system comprising:
a memory including instructions;
a first processor coupled to the memory and, when executing the instructions:
generates a broadcast operation; and
a broadcast operation subsystem that:
determines a partition identifier associated with the broadcast operation based on an identifier of a first user process that issued the broadcast operation;
generates a sub-partition mask based on the partition identifier, wherein the sub-partition mask identifies a subset of system components included in a plurality of system components assigned to the first user process; and
transmits the broadcast operation to the subset of system components based on the sub-partition mask.

13. The system of claim 12, wherein determining the partition identifier comprises:
accessing an entry in a lookup table entry comprising a configuration associated with the first user process, wherein the entry is identified by the identifier of the first user process; and
extracting the partition identifier from the entry.

14. The system of claim 13, further comprising:
determining that the first user process is idle; and
allowing the entry in the lookup table entry to be reconfigured while a second user process is executing.

15. The system of claim 12, wherein the identifier of the first user process is included in metadata associated with the broadcast operation.

16. The system of claim 12, further comprising:
receiving an acknowledgement from each system component the subset of system components, wherein the acknowledgement indicates that the corresponding system component has processed the broadcast operation; and
in response to receiving the acknowledgement from each system component, transmitting an acknowledgement to the first user process that the broadcast operation has been processed.

17. The system of claim 16, further comprising:
receiving an indication that the broadcast operation has been processed by each system component included in the subset of system components,
wherein transmitting the acknowledgement to the first user process is further in response to receiving the indication that the broadcast operation has been processed by each system component.

18. The system of claim 12, wherein:
the sub-partition mask comprises a bit mask, and
each bit included in the bit mask corresponds to a different system component included in the plurality of system components.

19. The system of claim 18, wherein:
a first bit included in the bit mask is in a first logic state when a system component corresponding to the first bit is included in the subset of system components, and
the first bit included in the bit mask is in a second logic state when the system component corresponding to the first bit is excluded from the subset of system components.

20. The system of claim 19, further comprising:
determining that the first bit included in the bit mask is in the first logic state; and
converting the first bit into an identifier that identifies the system component corresponding to the first bit.
